(19) United States
(12) Patent Application Publication
(10) Pub. No.: US 2015/0231748 A1
(43) Pub. Date: Aug. 20, 2015

(54) Pressing Mechanism For A Woodworking Machine

(71) Applicant: Kuang Yung Machinery Co., Ltd., Taichung City (TW)

(72) Inventor: Chao-Jen Chang, Taichung City (TW)

(73) Assignee: Kuang Yung Machinery Co., Ltd., Taichung City (TW)

(21) Appl. No.: 14/180,362

(22) Filed: Feb. 14, 2014

(51) Int. Cl. B23Q 3/06; B27G 19/00

(52) U.S. Cl. CPC B23Q 3/069; B27G 19/00

(57) ABSTRACT

A pressing mechanism for a woodworking machine includes a case, two buffering boards, two upright boards and a pressing frame. The case has multiple flat boards and multiple cushions are installed to the flat boards. The two buffering boards are pivotably connected beneath the cushions and each have a slot. The pressing frame is engaged with the two slots. Two arms are respectively and pivotably connected to two buffering boards. Each arm has a pivot connected to the first end thereof and the pivot is pivotably connected to the case. Each arm has a pressing bar connected to the second end thereof. The pressing bar is pivotably connected to the buffering board corresponding thereto. Each of the arms is pivotable about the pivot and the pressing bar is movable with the arm so as to balance the pressing frame to securely press the wood material to be cut.

### BACKGROUND OF THE INVENTION

(1) Fields of the Invention

The present invention relates to a pressing mechanism, and more particularly, to a pressing mechanism for a woodworking machine and the pressing mechanism press the wood board at a horizontal position so as to be cut without generating uneven surfaces.

(2) Descriptions of Related Art

The conventional wood cutting machine is able to cut wood material efficiently within a short period of time so that the cut wood plates or boards are ready to be manufactured to be furniture. It is known that the wood material has to be positioned firmly when being cut so as to have a neat cutting result. However, the wood material has different sizes and shapes before being cut. The wider wood boards can be easily pressed firmly, however, the narrow wood boards are different to be positioned, therefore, there will be uneven surfaces formed on the surface made by the blade, or the sides are not cut as desired. This makes the post processes to be difficult such as the adjacent wood plates or boards cannot be snugly matched to each other. A secondary treatment, such as milling may be required by either way of mechanical or manual way.

FIGS. 1 to 3 disclose a conventional pressing mechanism of a wood cutting machine 10 and comprises a case 11, a pair of arms 12, a pair of buffering board 13 and a pressing frame 14. There are multiple flat boards 101 in the case 11 so that the cushions 102 are installed to the flat boards 101, and the buffering boards 13 are pivotably connected beneath the cushions 102. The buffering boards 13 each have a slot 131 defined in the lower portion at the inside thereof so that the two sides of the pressing frame 14 are engaged with the two slots 131. The pressing frame 14 is located between the two buffering boards 13 and the blade is located between the two buffering boards 13. The two arms 12 are respectively connected to the two buffering boards 13. The two arms 12 each have one end fixed to the case 11 and the other end is pviotably connected to one of the buffering boards 13. The buffering board 13 having the arms 12 accepts the material fed in the machine. The other buffering board 13 does not connect with any arm 12. The two arms 12 are independent from each other.

When the wood material is fed into the machine and reaches the position beneath the pressing frame 14, the pressing frame 14 is lowered to press the wood material, and the blade cuts the wood material. When cutting the wood material, the pressing frame 14 presses the wood material so allow the blade to cut neatly.

However, the wider wood material can be firmly pressed by the pressing frame 14, but not the narrow wood material because only a portion of the narrow wood material is pressed by the pressing frame 14. After the blade cuts along a pre-set line, the wood material on the inside and on the outside of the pressing frame 14 are not located on the same horizontal plane, and the wood material is not firmly pressed. The uneven surface is formed when the blade cuts through the tilt wood material. A secondary treatment is required by either way of mechanical or manual way. This takes time and increases cost.

The present invention intends to provide a pressing mechanism of a wood cutting machine and improves the shortcomings mentioned above.

### SUMMARY OF THE INVENTION

The present invention relates to a pressing mechanism for a woodworking machine, and comprises a case having multiple flat boards located therein. Multiple cushions installed to the flat boards. Two buffering boards are pivotably connected beneath the cushions and each have a slot defined in the lower portion at the inside thereof. A pressing frame has two sides thereof engaged with the two slots of the two buffering boards so that the pressing frame is located between the two buffering boards. Two arms are respectively and pivotably connected to two respective outsides of the two buffering boards. Each arm has a pivot connected to the first end thereof and the pivot is pivotably connected to the case. Each arm has a pressing bar connected to the second end thereof. The pressing bar is pivotably connected to the buffering board corresponding thereto. Each of the arms is pivotable about the pivot and the pressing bar is movable with the arm. Two separation boards are located on two respective tops of the buffering boards. The pressing bar is movable with the arm so as to balance the left and right sides of the pressing frame to securely press the wood material to be cut.

The primary object of the present invention is to provide a pressing mechanism for a woodworking machine by using the pressing bar movable with the arm so as to balance the left and right sides of the pressing frame. The pressing frame presses the wood material to be cut horizontally so that no uneven surfaces are formed on the surface.

Another object of the present invention is to provide a pressing mechanism for a woodworking machine wherein the narrow wood plates can also be firmly pressed when being cut.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the conventional wood cutting machine;

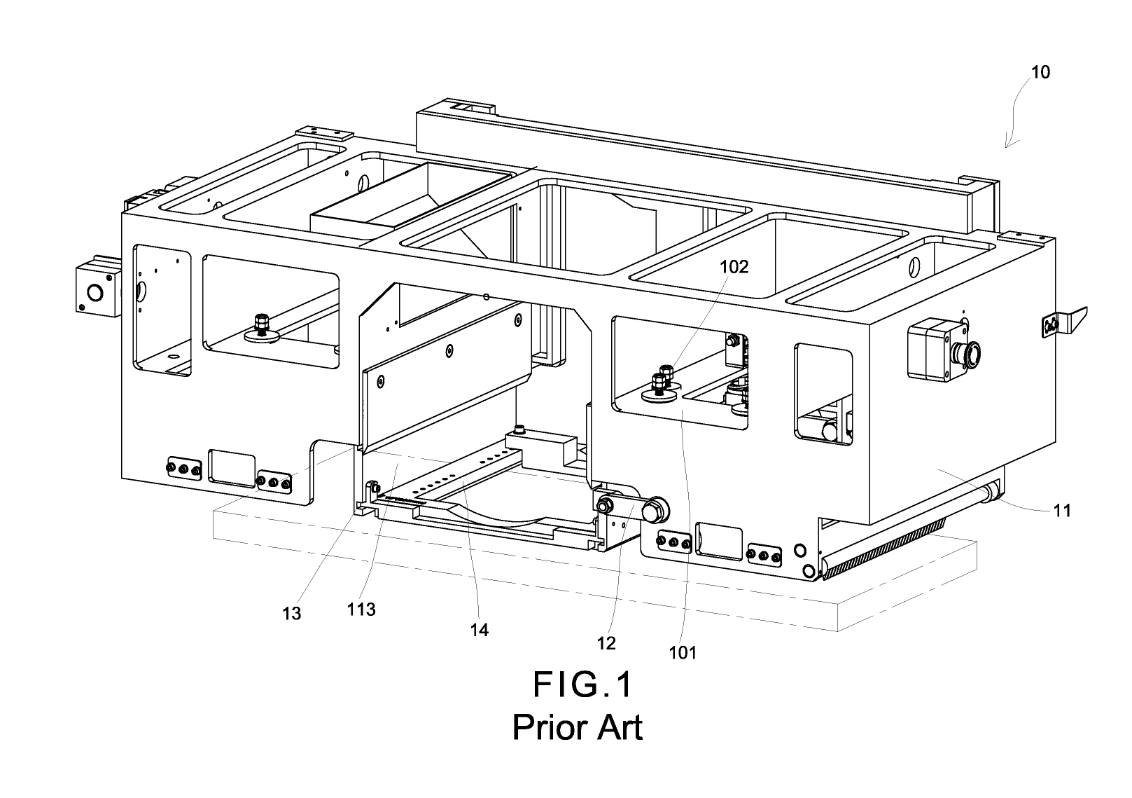

FIG. 2 is a perspective view to show the conventional pressing mechanism of the wood cutting machine in FIG. 1;

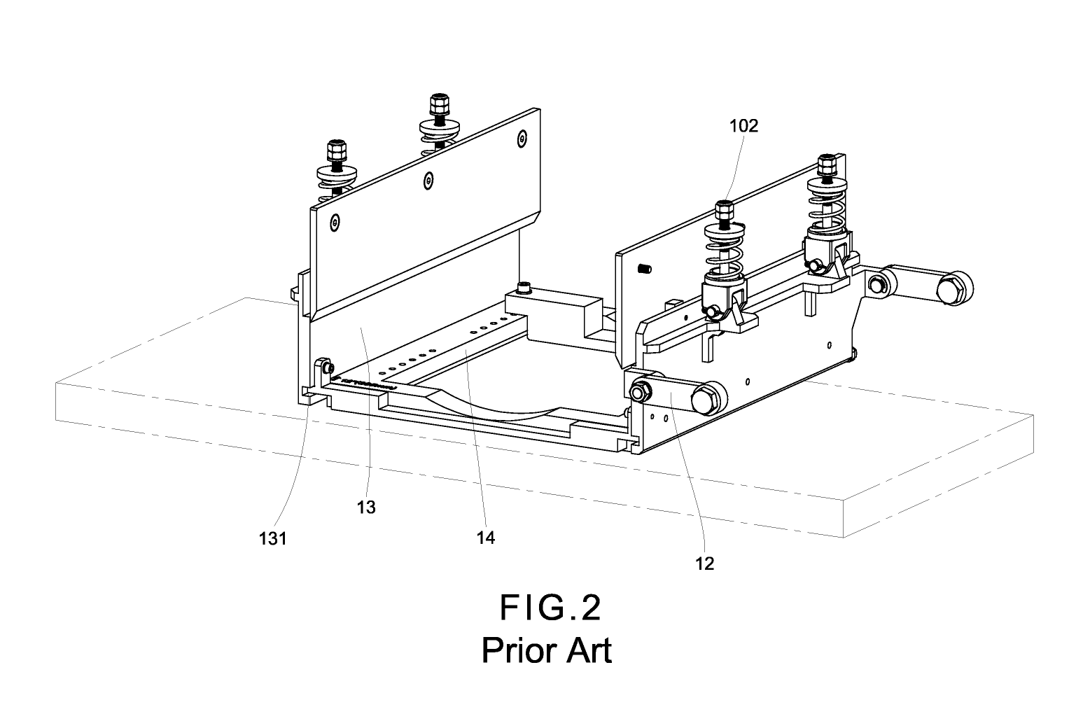

FIG. 3 is a plan view to show the conventional pressing mechanism of the wood cutting machine in FIG. 1;

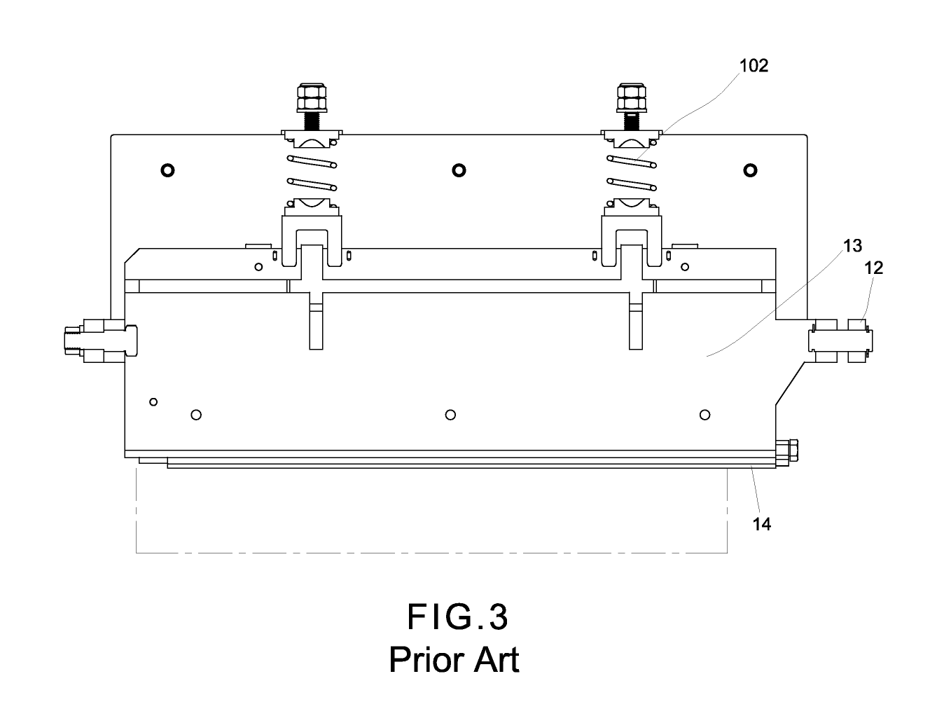

FIG. 4 is a perspective view to show the wood cutting machine of the present invention;

FIG. 5 is an exploded view of the pressing mechanism of the wood cutting machine of the present invention;

FIG. 6 is a perspective view to show the pressing mechanism of the wood cutting machine of the present invention, and

FIG. 7 is a plan view of the pressing mechanism of the wood cutting machine of the present invention.

### DETAILED DESCRIPTION OF THE PREFERRED EMBODIMENT

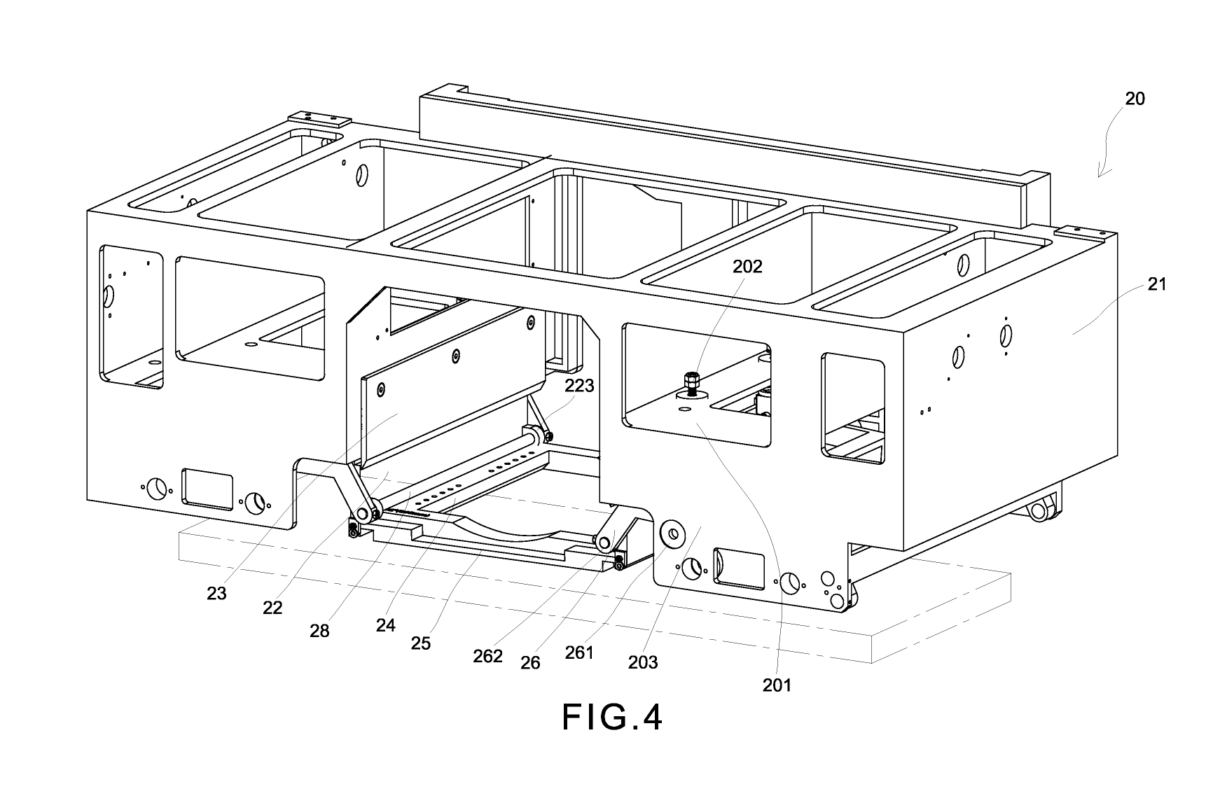

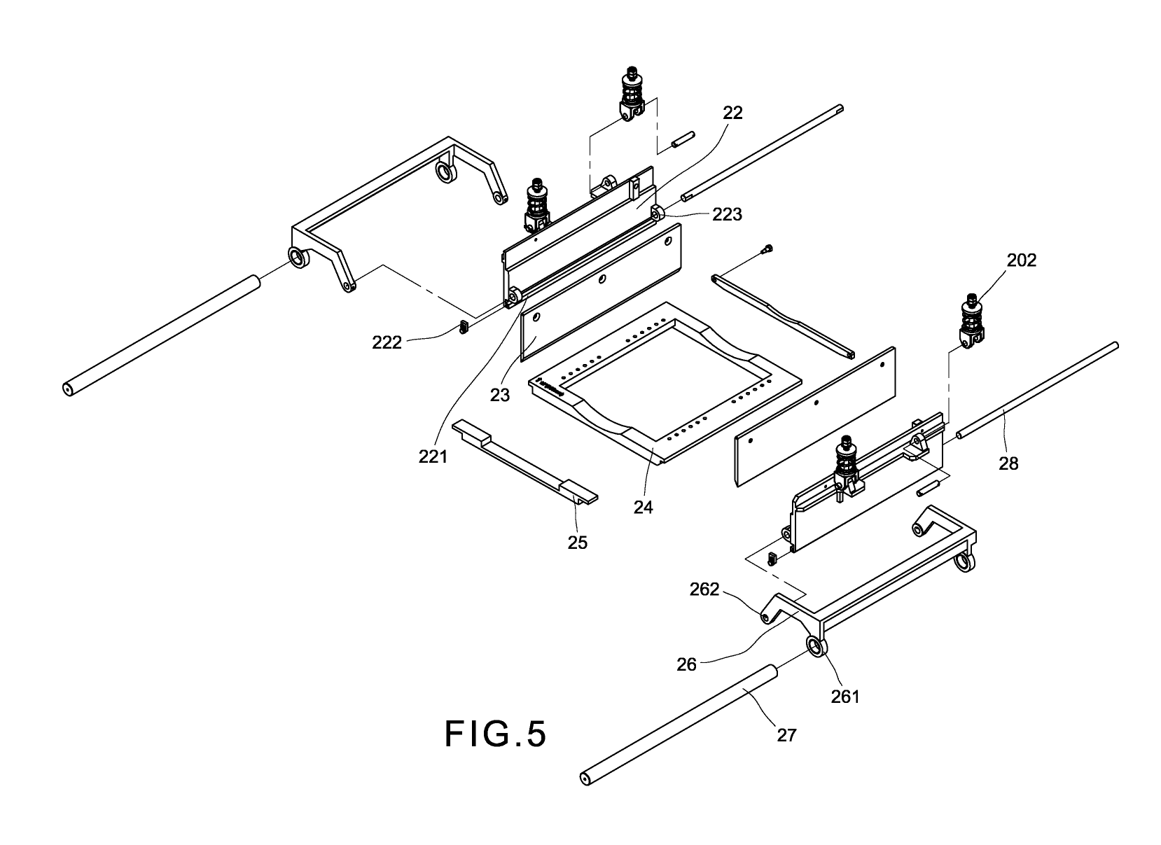

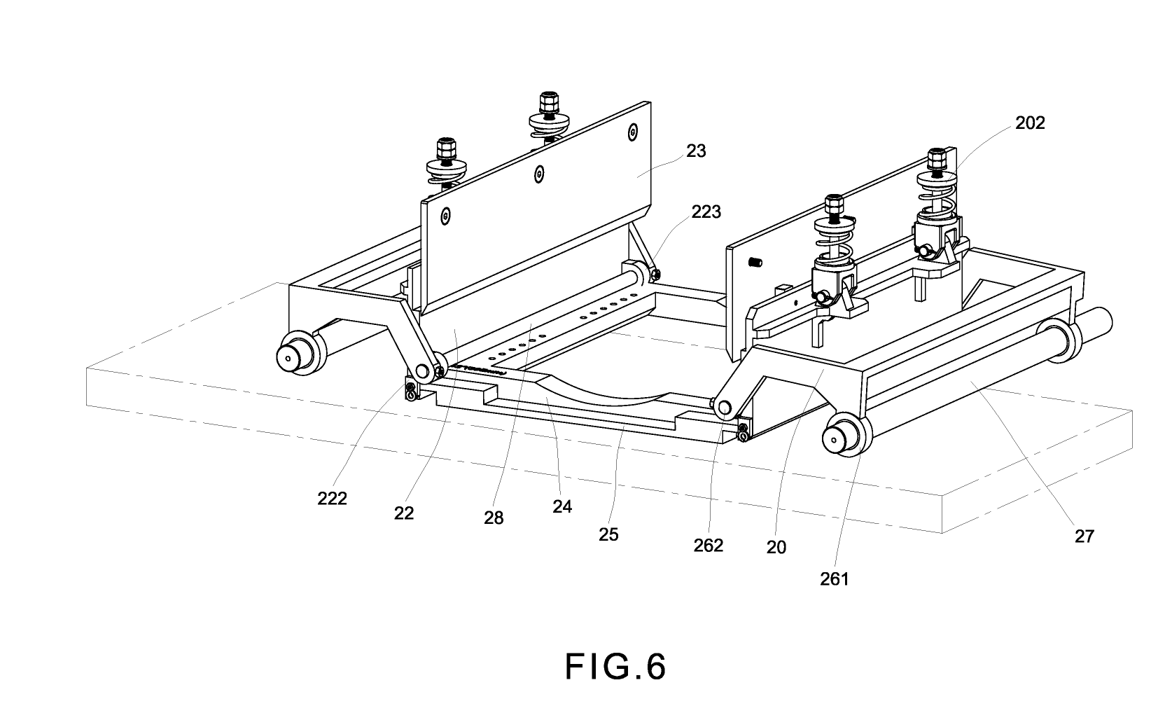

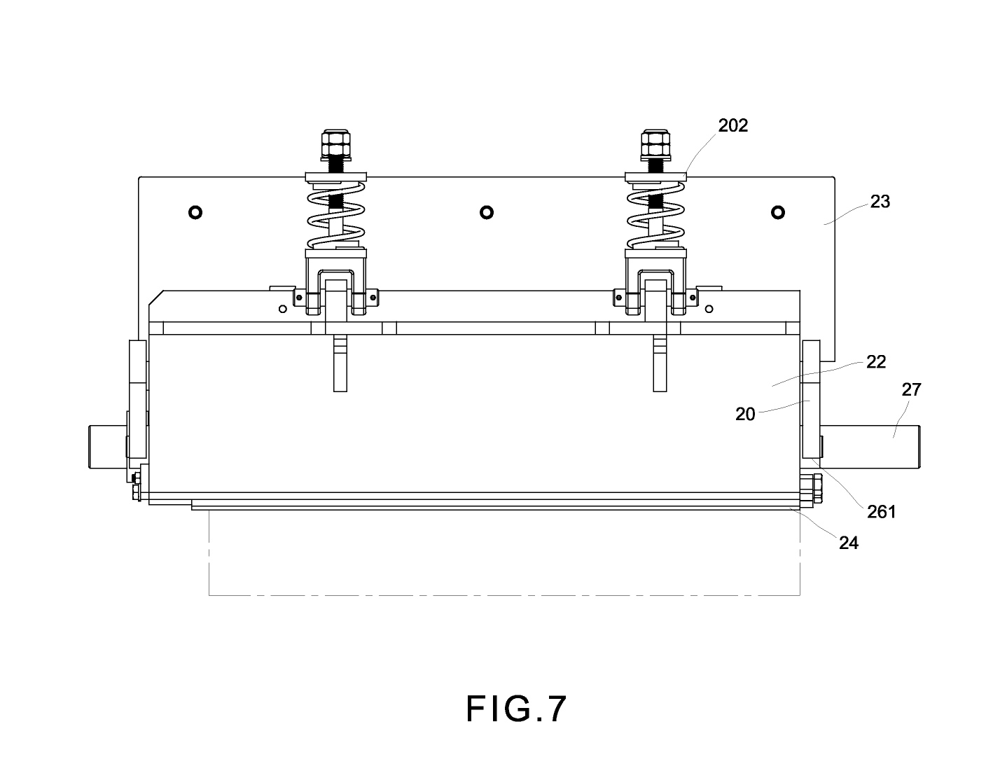

Referring to FIGS. 4 to 7, the wood cutting machine 20 of the present invention comprises a case 21, two buffering boards 22, two upright boards 23 and a pressing frame 24. The case 21 has multiple flat boards 201 located therein, and multiple cushions 202 are installed to the flat boards 201. The two buffering boards 22 are pivotably connected beneath the cushions 202 and each have a slot 221 defined transversely in the lower portion at the inside thereof. The slots 221 are sized such that the two sides of the pressing frame 24 are pressed into the slots 221 of the two buffering boards 22, so that the pressing frame 24 is located between the two buffering boards 22. Two locking plates 222 are connected to two ends of each of the two slots 221. The pressing frame 24 cannot move laterally by the restriction of the locking plates 222, and the pressing frame 24 is moved up and down with the movement of the buffering boards 22. Two restriction bars 25 are respectively connected to the front end and the rear end of the pressing frame 24. The blade is located between the two buffering boards 22.

Two arms 26 are respectively and pivotably connected to two respective outsides of the two buffering boards 22. Each arm 26 has a pivot 27 connected to the first end thereof and the pivot 27 is pivotably connected to the case 21. Two first rings 261 are formed on the first end of each of the arms 26 and the two first rings 261 are fixed to the walls 203 of the case 21. The pivot 27 extends through the two first rings 261. Therefore, the arm 26 can be pivoted about the pivot 27. Each arm 26 has two holes 262 defined in the second end thereof. A pressing bar 28 extends through the two holes 262. The pressing bars 28 are pivotably connected to the buffering boards 22 respectively. Each of the arms 26 is pivotable about the pivot 27 and the pressing bar 28 is movable with the arm 26. The buffering boards 22 each have two second rings 223 on two sides thereof and the pressing bar 28 extends through the two second rings 223.

When in operation, the wood material is sent into the wood cutting machine 20 from the entrance of the case 21. The wood material is moved to a position beneath the pressing frame 24, and the pressing frame 24 is then lowered to press the wood material. The blade cuts the wood material which is pressed firmly by the pressing frame 24 so that the cutting result is satisfied. If the wood material is narrow and only the inside of the pressing frame 24 presses on the wood material, but the pressing bars 28 make the left and right sides of the pressing frame 24 to be located on the same horizontal plane, so that the narrow wood material is pressed properly. Even the wood material leaves from the blade, the wood material still pressed properly by the pressing frame 24. Therefore, uneven surfaces can be avoided after being cut.

Bu the pressing bars 28 synchronically moved its the left and right sides, the pressing frame 24 firmly presses the narrow wood material and the wood material is cut without uneven surfaces formed. Therefore, there will be no need to proceed secondary treatments.

While we have shown and described the embodiment in accordance with the present invention, it should be clear to those skilled in the art that further embodiments may be made without departing from the scope of the present invention.

What is claimed is:

1. A pressing mechanism for a woodworking machine, comprising:
a case having multiple flat boards located therein, multiple cushions installed to the flat boards;
two buffering boards pivotably connected beneath the cushions, the buffering boards each having a slot defined in a lower portion at an inside thereof, two arms respectively and pivotably connected to two respective outsides of the two buffering boards, each arm having a pivot connected to a first end thereof and the pivot being pivotably connected to the case, each arm having a pressing bar connected to a second end thereof, the pressing bar being pivotably connected to the buffering board corresponding thereto, each of the arms being pivotable about the pivot and the pressing bar being movable with the arm;
a pressing frame having two sides thereof engaged with the two slots of the two buffering boards, the pressing frame located between the two buffering boards, and
two separation boards located on two respective tops of the buffering boards.

2. The pressing mechanism as claimed in claim 1, wherein two restriction bars are respectively connected to a front end and a rear end of the pressing frame.

3. The pressing mechanism as claimed in claim 1, wherein the arms each have two first rings on the first end thereof and the two first rings are fixed to the case, the pivot extends through the two first rings.

4. The pressing mechanism as claimed in claim 1, wherein the arms each have two holes defined in the second end thereof, the pressing bar extends through the two holes.

5. The pressing mechanism as claimed in claim 1, wherein two locking plates are connected to two ends of each of the two slots.

6. The pressing mechanism as claimed in claim 1, wherein the buffering boards each have two second rings on two sides thereof and the pressing bar extends through the two second rings.
